(19) United States
(12) Patent Application Publication
(10) Pub. No.: US 2005/0123289 A1
(43) Pub. Date: Jun. 9, 2005

(54) Method and apparatus for observing objects with a microscope

(75) Inventor: Achim Schweikard, Hamburg (DE)

Correspondence Address: ALIX YALE & RISTAS LLP, 750 MAIN STREET, SUITE 1400, HARTFORD, CT, 06103, US

(73) Assignee: Moller-Wedel GmbH

(21) Appl. No.: 10/975,734

(22) Filed: Oct. 27, 2004

(30) Foreign Application Priority Data
Dec. 5, 2003 (EP) 03 028 127.3

(51) Int. Cl. G03B 35/02

(52) U.S. Cl. 396/329

(57) ABSTRACT

The method and the apparatus for observing objects from various viewing directions by means of a microscope having a device for electronically storing images and computer-controlled drive devices for a plurality of axes of motion, are characterized in that a first recording of the target region of the object is created and stored, the microscope is pivoted by a defined angle, a second recording of the target region is created and stored, one and the same point (1) of the object is marked in both recordings, the coordinates of the point are calculated by triangulation, and the control is set up in such a way that it is possible to carry out a pivot movement about the set point.

The invention relates to a method and an apparatus for observing objects from various viewing directions by means of a microscope having a device for electronically storing images and computer-controlled drive devices for a plurality of axes of motion.

Microscopes which can be moved about a plurality of axes of motion of a stand in a computer-controlled manner are known. These microscopes can be moved translationally or else be pivoted. In many cases, however, it is desirable to be able to observe a specific point of the object from different directions. Although this is not of great significance in the case of two-dimensional objects, it may be important for three-dimensional objects, particularly if the point to be observed is partially concealed by parts of the object that are closer to the microscope. In this case, it is difficult to carry out the control of the movement of the microscope such that the same point always remains in the field of view but it can nevertheless by observed from different angles.

The object of the invention is to provide a method by which it is possible to carry out a pivot movement about the point to be observed without this point shifting or its image becoming unsharp.

The solution according to the invention consists of the fact that a first recording of the target region of the object is created and stored, the microscope is pivoted by a defined angle, a second recording of the target region is created and stored, one and the same point of the object is marked in both recordings, the coordinates of the point are calculated by triangulation, and the control is set up in such a way that it is possible to carry out a pivot movement about the set point.

It is thus necessary to choose two angles or viewing directions at which one and the same point can be observed. Afterwards, the pivot movement about this point is then set up on the basis of the two recordings. It is then possible to execute this pivot movement in order to find viewing directions or angle settings which show the point and its surroundings possibly even better than was the case in the original recordings. The optimum observation conditions can thus be created particularly in the case of operations e.g. on the brain.

Advantageously, the control is set up in such a way that not only pivot movements but also translational movements of the microscope can be carried out. In this way, it is possible to move other parts of the object into the field of view and, if appropriate, to set up a pivot movement about these points.

Advantageously, an acquisition and calculation are carried out for a plurality of points of the object.

In this case, use is expediently made of a microscope with devices for mirroring in data and images. In this case, the devices for mirroring in data may be devices for mirroring in data of the movement control.

Expediently, the devices are in this case designed for mirroring in images of the object obtained in a different manner. This, too, is advantageous for operations on the brain, but not only for such operations. The images of the object obtained in a different manner may be preoperative recordings in the case of the brain operation (e.g. MRT, CT, X-ray, ultrasound, PET or angiography data). In this way, the operator can “see” details lying below the surface visible to him through the microscope. Expediently, the points which correspond to the image points marked in the stored microscope recordings are marked in the images of the object obtained in a different manner. It is then possible to determine the shifts of the points observed by means of the microscope relative to the locations of the points in the images obtained in a different manner. This shift is known as “brain shift” in the case of brain operations. This deformation of the anatomical structures arises for example if the operation zone is opened up and bone is removed in order to allow access, or else if parts of a tumour have already been removed at the beginning of an operation. As a result, it is often possible only with difficulty to intraoperatively assign anatomical structures to the corresponding structures known from the three-dimensional preoperative images. Whereas the preoperatively recorded images often have high resolution and reveal structures highly visibly, this is often difficult during the operation just on account of the intraoperatively visible surface. If a shift function is then determined by interpolation for the points arranged between marked points, which shift function is also advantageously extrapolated beyond the marked points, then the images obtained in a different manner can be deformed using this shift function in such a way that the marked points in the said images coincide with corresponding points observed with the microscope. In this case, despite the brain shift, the operator can see the same site in the brain in superimposed fashion, namely on the one hand directly through the microscope and on the other hand overlaid by the preoperative recording.

An apparatus for carrying out the method with a microscope having a device for electronically storing images and computer-controlled drive devices for a plurality of axes of motion, is characterized in that it has devices for mirroring in control data of the drive devices. Expediently, the drive devices can be controlled in a wire-free manner by means of a sterilizable unit having an actuation button for the type of movement and an actuation button for the execution of a movement step. The said sterilizable unit may be fitted e.g. to the surgical instrument, so that the operator does not have to put the latter aside if he wishes to adjust the microscope. The wire-free connection between the sterilizable unit arranged on the surgical instrument may be e.g. a radio link or an ultrasonic connection.

In this case, the computer control may be designed for effecting translational and pivot movements.

The presettings provided by means of the switches are inserted by means of the device for mirroring in control data. Drives which permit the microscope to be automatically tracked without jerkiness are integrated into the control of the microscope. By means of an apparatus of this type, the microscope is tracked by the following method steps:
1. The subsequent movement action can be preselected by actuation of a switching element
2. The movement action then selected is indicated at the edge of the field of vision of the microscope
3. Subsequent actuation of the other switching element executes the movement action respectively indicated
4. The movement action is provided in three translational directions
5. A fixed step size (e.g. 3 mm) can be preselected for the movement
6. An overshoot is in each case prevented by means of suitable robotic control methods.
7. Instead of the three translational directions mentioned, it is also possible to effect pivoting about a point selected in the working space.

The method and the apparatus of the invention also make it possible to define an arbitrary point of the object as a new pivot point, as was explained further above, which is done essentially with the aid of two recordings, marking of the same point in both recordings and triangulation of the coordinates of the point.

If the apparatus provided with devices for marking points both in the electronically stored images and in the images obtained in a different manner and devices for determining the shift, then the procedure may be as follows:

If a plurality of spatial points are defined in that way, and if some of these points have also already been marked in preoperative recordings (e.g. MRT, CT, X-ray, ultrasound, PET or angiography data), then it is possible to establish a correspondence between the points. In particular, it is possible to calculate a mathematical deformation function which precisely transfers the preoperative points into the intraoperative points. As a result, it becomes possible to mirror in the position of hidden points in the anatomy which are currently not visible but are discernible in preoperative images. In particular, the method described results in a possibility of compensating for the brain shift, that is to say the intraoperative deformation of the tissue, and nevertheless of permitting a navigation. An essential advantage of the method according to the invention is the possibility of dispensing with an external position tracking system.

Other previously known work attempts to compensate for the so-called brain shift by means of simulation methods. In this case, steps and their effects are simulated on a computer, and the effect is subsequently counted back as a compensating deformation. This approach affords only very inaccurate results, however, since this would require using only exactly the planned sections, which is seldom possible in practice.

Navigation methods propose mirroring in the preoperative data intraoperatively. For this purpose, known methods use a position tracking system, for example a commercially available infrared-based navigation system. Such a system is costly and not able by itself to compensate for the brain shift. Combination with the previously mentioned simulation methods also affords only very inaccurate results here, since here, too, it would be necessary to use only the planned sections.

The problems of the prior art are avoided by virtue of the fact that the drive devices can be controlled in a wire-free manner by means of a sterilizable unit. The movement can be effected directly by the surgeon. Although voice control is conceivable, the latter works unreliably under OP conditions and is at odds with ergonomic requirements from the application. In other previously known devices, it is necessary to have to put the operation instrument down in the meantime. Operational control by foot- or mouth-operated switches is likewise at odds with ergonomic requirements.

The essential points of the invention may be summarized as follows. The invention relates to a method for navigation by means of a surgical microscope, in which it is possible to compensate for the intraoperative deformation of the tissue during an operation. The starting point is the already known microscope systems in which individual axes of motion in the support stand are equipped with computer-controlled drives. Parameters of a spatial movement that is to be executed by the microscope are prescribed by means of sterilizable switching elements fitted to the surgical instrument. The settings effected by the switching elements can be visualized by mirroring into the viewing window of the microscope and subsequently be updated. The microscope is moved in preselected step sizes. As a result, the microscope can be tracked in a simple manner during the operation. The tracking requires movement on a spherical volume about a fixed spatial point. This point must be suitably defined at the beginning of the operation. In order to define this point, the procedure is such that firstly a point in the target anatomy is marked by an electronically detectable pointer, e.g. mouse pointer, then the robot-controlled microscope is moved at a fixed angle known to the system, and the same point is marked anew. Since the relative position of the two images is known, the precise spatial position of this point can be calculated. A plurality of such points are then acquired in the same way. If the same points have then been marked in a preoperatively acquired data record, the mathematical deformation function can be calculated, which transfers the preoperative set of points into the intraoperative stet of points. As a result, further preoperatively marked or acquired information can subsequently be mirrored into the viewing window of the microscope. In particular, the precise current position of structures hidden below the surface can be visualized during the operation without requiring an external navigation system (tracking system).

The invention is explained below by way of example in the figures:

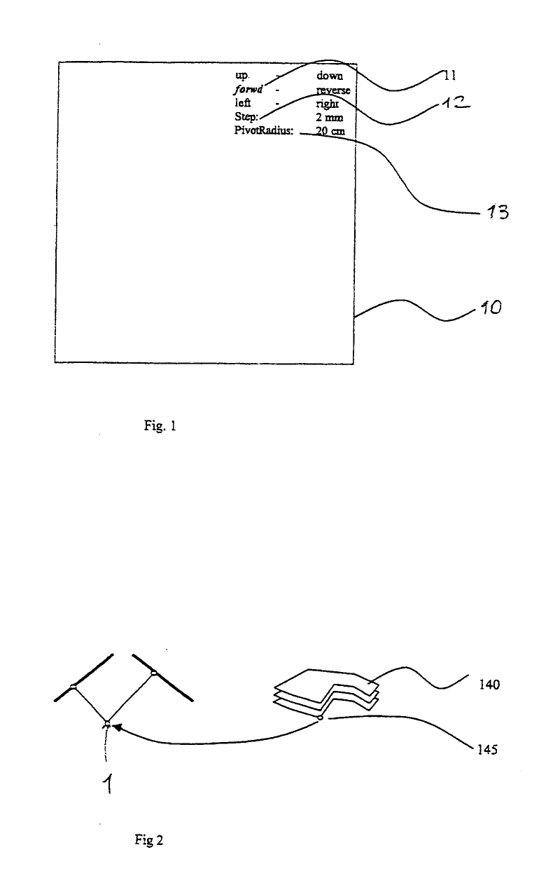

FIG. 1 shows the movement parameters mirrored into the image field of the microscope;

FIG. 2 schematically shows the application of the method of the invention;

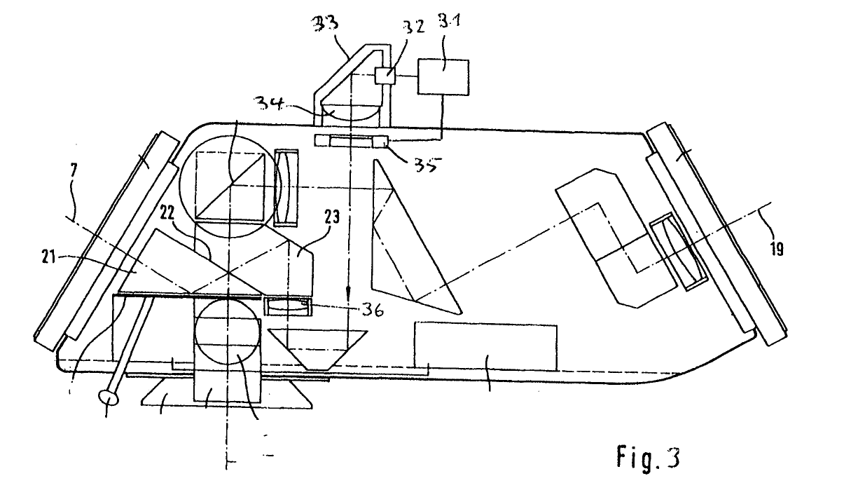

FIG. 3 schematically shows the radiation path of a microscope according to the invention; and

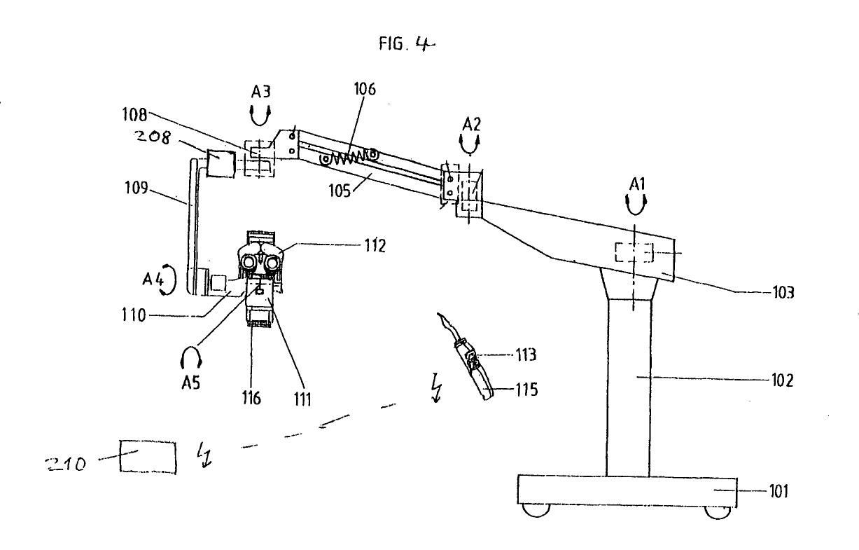

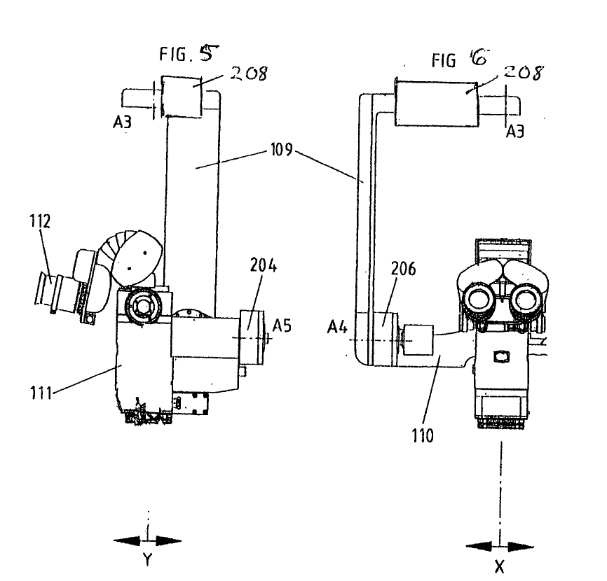

FIGS. 4-6 show the illustration of a microscope stand with the drive devices according to the invention.

FIG. 1 schematically shows the image field 10 of a microscope, into which the various movement possibilities are mirrored. In this case, the currently chosen direction of movement is highlighted at 11 (brighter, contrasting colour or in italics). The step size is represented at 12, while the pivot radius is represented at 13.

The observation of a point 1 from two different viewing angles is indicated on the left in FIG. 2. The precise location of this point 1 can then be ascertained by triangulation. The corresponding point 145 in images obtained in a different manner (the figure shows a plurality of layer representations 140 which have been obtained e.g. by magnetic resonance tomography) in this case corresponds to the point 1 and can be mathematically correlated with the latter in order to compensate for the brain shift.

The microscope illustrated schematically in FIG. 3 has a projection unit in which an image can be generated with the aid of electronic circuits 31. In this case, the circuit 31 also feeds a light source 32 in the form e.g. of a lamp or an LED, the light from which is e.g. diffusely deflected at 33 into a collimator lens 34, which sends the light through a transparent display 35, in which an image is generated with the aid of the circuit 31. The said image is conducted via a lens 36 and further optical elements shown in FIG. 1 into a prism 23, which is constructed together with the prism 21 and shares the beam splitter area 22. In this case, one part of the light coming from the projection unit 31-35 is sent into the beam path 7 for the main observer, while the other part is either deflected out laterally to a connecting device for the co-observer tube into the beam path 19 for the co-observer or else is deflected out laterally together with the main beam path.

FIG. 4 illustrates the arrangement of an operation microscope on a floor stand. The stand is situated on a base part or foot 101, which is generally equipped with rollers for movement. It goes without saying that the base part 101 may also be designed for ceiling or wall fixing. A column 102 is fitted on the said base part 101, and the emplaced fixed arm 103 can rotate about the axis A1 of the said column. A parallelogram arm 105 is fixed thereto by means of a joint that can be rotated about the axis A2. The height adjustment of the microscope connection 108 on the parallelogram arm 105 is weight-counterbalanced by means of a gas spring or a spring assembly 106.

The microscope comprises a microscope body 111, the viewer 112 and the objective 116 and is fixed to the microscope connection of the stand by means of the arms 110 and 109 such that it can be rotated about the axis A3. It can be moved in a manner free of the influence of gravity, except for frictional resistances, in the mechanically prescribed space by means of the rotations about the axes A1, A2 and A3 and also by means of the weight-counterbalanced height adjustment with the parallelogram arm 105.

As is illustrated in FIGS. 4-6, the microscope 111 illustrated therein, with the drive 204, can be rotated about the axis A5. This corresponds to a rotation in the visual field in the X direction. Together with the arm 110, the microscope 111 can be rotated about the axis A4 by the drive 206. This corresponds to a movement in the visual field upwards/downwards (Y direction).

In addition to the drive devices 204 and 206 for the axes A5 and A4, provision is made for a drive device 208, which enables an adjustment of the microscope arm 109 and thus of the microscope 111 in three different directions perpendicular to one another. In this case, the control is effected by means of a control unit 210, which is illustrated schematically in FIG. 4 and is connected to the adjusting devices 204, 206, 208 via cables (not shown). In this case, the control unit 210 is controlled by a remote control unit 115 with actuating keys 113, the said remote control unit being connected to the surgical instrument.

The calculations e.g. for determining the shift function by interpolation and/or extrapolation and for deformation of the images obtained in a different manner, are likewise effected in the control unit 210. The marking of points may be effected e.g. by actuation of the keys 113 of the wire-free control 115.

1. Method for observing objects from various viewing directions by means of a microscope having a device for electronically storing images and computer-controlled drive devices for a plurality of axes of motion, characterized in that
a first recording of the target region of the object is created and stored, the microscope is pivoted by a defined angle,
a second recording of the target region is created and stored, one and the same point of the object is marked in both recordings,
the coordinates of the point are calculated by triangulation, and
the control is set up in such a way that it is possible to carry out a pivot movement about the set point.

2. Method according to claim 1, characterized in that the control is set up in such a way that translation movements of the microscope can be carried out.

3. Method according to claim 1, characterized in that the acquisition and calculation are carried out for a plurality of points of the object.

4. Method according to claim 1, characterized in that use is made of a microscope with devices for mirroring in data and images.

5. Method according to claim 4, characterized in that the devices are designed for mirroring in data of the movement control.

6. Method according to claim 4, characterized in that the devices are designed for mirroring in images of the object obtained in a different manner.

7. Method according to claim 6, characterized in that the points which correspond to the image points marked in the stored microscope recordings are marked in the images of the object obtained in a different manner.

8. Method according to claim 7, characterized in that shifts of the points observed by means of the microscope relative to the locations of the points in the images obtained in a different manner are determined.

9. Method according to claim 8, characterized in that a shift function is determined by interpolation for the points arranged between the marked points.

10. Method according to claim 9, characterized in that the shift function is extrapolated beyond the marked points.

11. Method according to claim 9, characterized in that the images obtained in a different manner are deformed using the shift function in such a way that the marked points in the said images coincide with the corresponding points observed with the microscope.

12. Apparatus for carrying out the method according to claim 1 with a microscope having a device for electronically storing images and computer-controlled drive devices for a plurality of axes of motion, characterized in that it has devices for mirroring in control data of the drive devices.

13. Apparatus according to claim 12, characterized in that the drive devices can be controlled in a wire-free manner by means of a sterilizable unit having an actuation button for the type of movement and an actuation button for the execution of a movement step.

14. Apparatus according to claim 12, characterized in that the computer control is designed for effecting translational and pivot movements.

15. Apparatus according to claim 12, characterized in that it has a device for mirroring images of the object obtained in a different manner into the image field of the microscope.

16. Apparatus according to claim 15, characterized in that it has devices for marking points in the electronically stored images and the images obtained in a different manner and devices for determining the shift of the points observed by means of the microscope relative to the locations of the points in the images obtained in a different manner.

17. Apparatus according to claim 16, characterized in that it has devices for determining a shift function by interpolation for the points arranged between the marked points.

18. Apparatus according to claim 17, characterized in that the devices are designed for determining the shift function for extrapolation beyond the marked points.

19. Apparatus according to claim 17 or 18, characterized in that it has devices for deforming the images obtained in a different manner using the shift function in such a way that the marked points in the images obtained in a different manner coincide with the corresponding points observed with the microscope.

20. Apparatus according to claim 13, characterized in that the computer control is designed for effecting translational and pivot movements.
